(19) United States
(12) Patent Application Publication
(10) Pub. No.: US 2024/0171990 A1
(43) Pub. Date: May 23, 2024

(54) ICON DISPLAY FOR NON-TERRESTRIAL NETWORKS

(71) Applicant: QUALCOMM Incorporated, San Diego, CA (US)

(72) Inventors: Bapineedu Chowdary GUMMADI, Hyderabad (IN); Avinash SHRIVASTAVA, Hyderabad (IN); Uttam VYAS, Hyderabad (IN)

(21) Appl. No.: 17/991,700

(22) Filed: Nov. 21, 2022

(51) Int. Cl. H04W 16/18; G06F 3/04817

(52) U.S. Cl. CPC H04W 16/18; G06F 3/04817

(57) ABSTRACT

A method of wireless communication, by a user equipment (UE), includes scanning a wireless network for a system information message containing inter-radio access technology (IRAT) frequency information for a non-terrestrial network. The method also includes displaying a non-terrestrial network icon on a user interface of the UE in response to receiving the system information message. The icon indicates non-terrestrial network coverage.

### FIELD OF THE DISCLOSURE

The present disclosure relates generally to wireless communications, and more specifically to icon display for non-terrestrial networks.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP).

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method of wireless communication, by a user equipment (UE) includes scanning a wireless network for a system information message containing inter-radio access technology (IRAT) frequency information for a non-terrestrial network. The method also includes displaying a non-terrestrial network icon on a user interface of the UE in response to receiving the system information message. The icon indicates non-terrestrial network coverage.

Other aspects of the present disclosure are directed an apparatus. The apparatus has a memory and one or more processors coupled to the memory. The processor(s) is configured to scan a wireless network for a system information message containing inter-radio access technology (IRAT) frequency information for a non-terrestrial network. The processor(s) is also configured to display a non-terrestrial network icon on a user interface of the UE in response to receiving the system information message. The icon indicates non-terrestrial network coverage.

Other aspect of the present disclosure are directed an apparatus. The apparatus includes means for scanning a wireless network for a system information message containing inter-radio access technology (IRAT) frequency information for a non-terrestrial network. The apparatus also includes means for displaying a non-terrestrial network icon on a user interface of the UE in response to receiving the system information message. The icon indicates non-terrestrial network coverage.

In other aspects of the present disclosure, a non-transitory computer-readable medium with program code recorded thereon is disclosed. The program code is executed by a processor and includes program code to scan a wireless network for a system information message containing inter-radio access technology (IRAT) frequency information for a non-terrestrial network. The program code also includes program code to display a non-terrestrial network icon on a user interface of the UE in response to receiving the system information message. The icon indicates non-terrestrial network coverage.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a block diagram illustrating an example of a wireless communications network for non-terrestrial networks, in accordance with various aspects of the present disclosure.

FIG. 5A is a diagram illustrating a non-terrestrial network coverage icon, in accordance with various aspects of the present disclosure.

FIG. 5B is a diagram illustrating a high brightness non-terrestrial network coverage icon, in accordance with various aspects of the present disclosure.

FIG. 6 is a block diagram illustrating a coverage gap in a non-terrestrial network, in accordance with various aspects of the present disclosure.

FIG. 7 is a block diagram illustrating a non-terrestrial network coverage icon during a coverage gap, in accordance with various aspects of the present disclosure.

FIG. 8 is a flow diagram illustrating an example process performed, for example, by a user equipment, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Non-terrestrial networks (NTN) have been introduced to provide ubiquitous network coverage, especially in regions where terrestrial networks are unavailable or have poor coverage. Non-terrestrial networks may also be used in case terrestrial networks are damaged. For non-terrestrial networks (NTN), it may be desirable for a user equipment (UE) to display an icon indicating whether the UE is in a coverage area of a non-terrestrial network. Such an icon is desirable because NTN service may be considered a different service than cellular service. Aspects of the present disclosure are related to techniques for displaying an NTN icon.

In some examples, if a UE cannot find a non-terrestrial network to camp on, an NTN icon is not displayed. In some other examples, if the UE is camped on a terrestrial network and non-terrestrial network is available, then an NTN icon is displayed. In some aspects, the NTN icon is displayed with low brightness when the non-terrestrial network is available but not camped on. If the UE is camped on a non-terrestrial network, an NTN icon may be displayed with high brightness. If the UE is in a non-terrestrial network coverage gap, a timer may be displayed to indicate when non-terrestrial coverage will return.

Particular aspects of the subject matter described in this disclosure can be implemented to realize one or more of the following potential advantages. In some examples, the described techniques, such as displaying an NTN icon, may enable a user to select a preferred network or decide whether a particular application should be run. Display of the icon may also enable a user to plan for when a coverage gap will end.

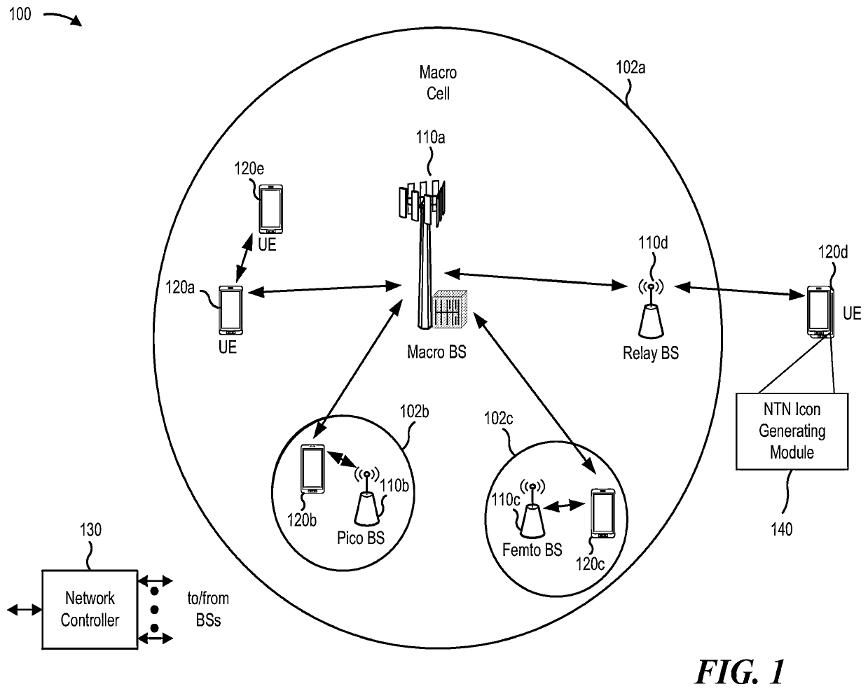

FIG. 1 is a block diagram illustrating an example of a wireless communications network 100 in which aspects of the present disclosure may be practiced. The wireless network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “TRP,” “AP,” “node B,” “5G NB,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types, e.g., macro BSs, pico BSs, femto BSs, relay BSs, and/or the like. These different types of BSs may have different transmit power levels, different coverage areas, and different impact on interference in the wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. The network controller 130 may communicate with the BSs via a backhaul. The BSs may also communicate with one another, e.g., directly or indirectly via a wireless or wireline backhaul.

The network controller 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The network controller 130 may provide user authentication, access authorization, tracking, IP connectivity, and other access, routing, or mobility functions. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IOT) devices, and/or may be implemented as NB-IOT (narrow band internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

The UEs 120 may include a non-terrestrial network (NTN) icon generating module 140. For brevity, only one UE 120d is shown as including the NTN icon generating module 140. The NTN icon generating module 140 scans a wireless network for a system information message containing inter-radio access technology (IRAT) frequency information for a non-terrestrial network. The NTN icon generating module 140 may also display a non-terrestrial network icon on a user interface of the UE in response to receiving the system information message. The icon indicates non-terrestrial network coverage.

As indicated above, FIG. 1 is provided merely as an example. Other examples may differ from what is described with regard to FIG. 1.

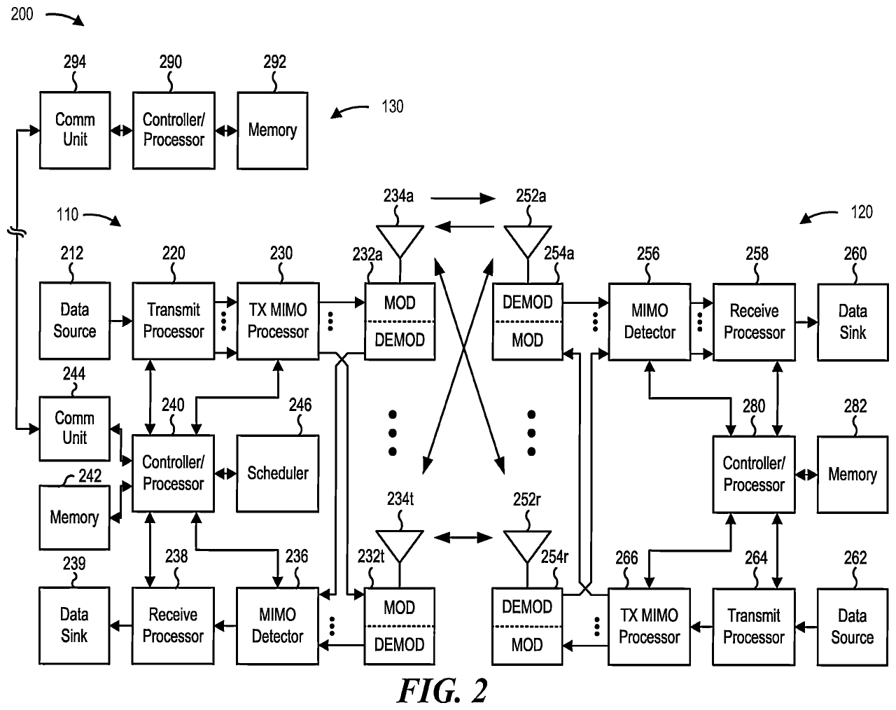

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below; the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the network controller 130 via the communications unit 244. The network controller 130 may include a communications unit 294, a controller/processor 290, and a memory 292.

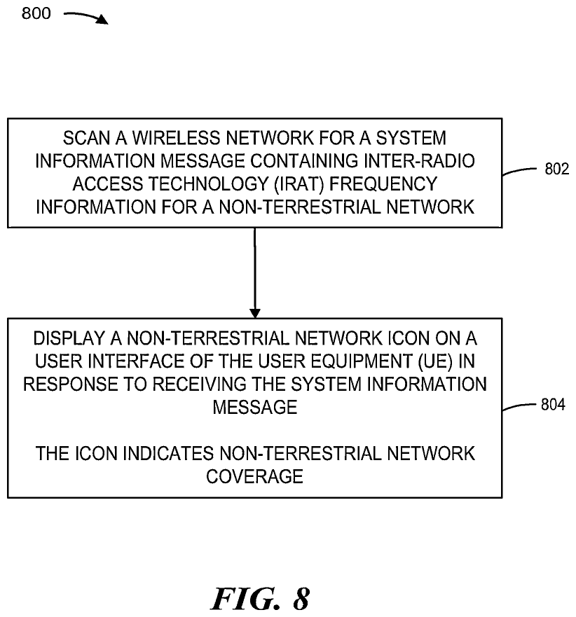

The controller/processor 240 of the base station 110, the controller/processor 280 of the UE 120, and/or any other component(s) of FIG. 2 may perform one or more techniques associated with icon display for non-terrestrial network, as described in more detail elsewhere. For example, the controller/processor 240 of the base station 110, the controller/processor 280 of the UE 120, and/or any other component(s) of FIG. 2 may perform or direct operations of, for example, the process of FIG. 8 and/or other processes as described. Memories 242 and 282 may store data and program codes for the base station 110 and UE 120, respectively. A scheduler 246 may schedule UEs for data transmission on the downlink and/or uplink.

In some aspects, the UE 120 may include means for scanning, means for displaying, and means for receiving. Such means may include one or more components of the UE 120 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IOT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

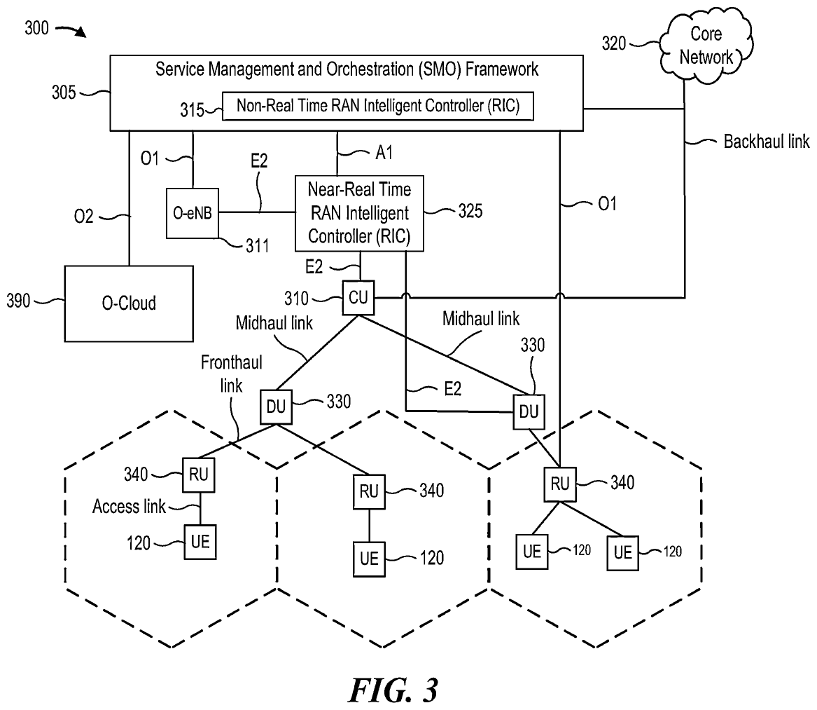

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a virtualized radio access network (vRAN) architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

Non-terrestrial networks (NTN) have been introduced to provide ubiquitous network coverage. The network coverage may be provided in regions where terrestrial networks are unavailable or have poor coverage, such as over oceans, or in mountainous areas, rural areas, forests, etc. Non-terrestrial networks may also be used in case terrestrial networks are damaged, for example, due to natural disasters or other reasons.

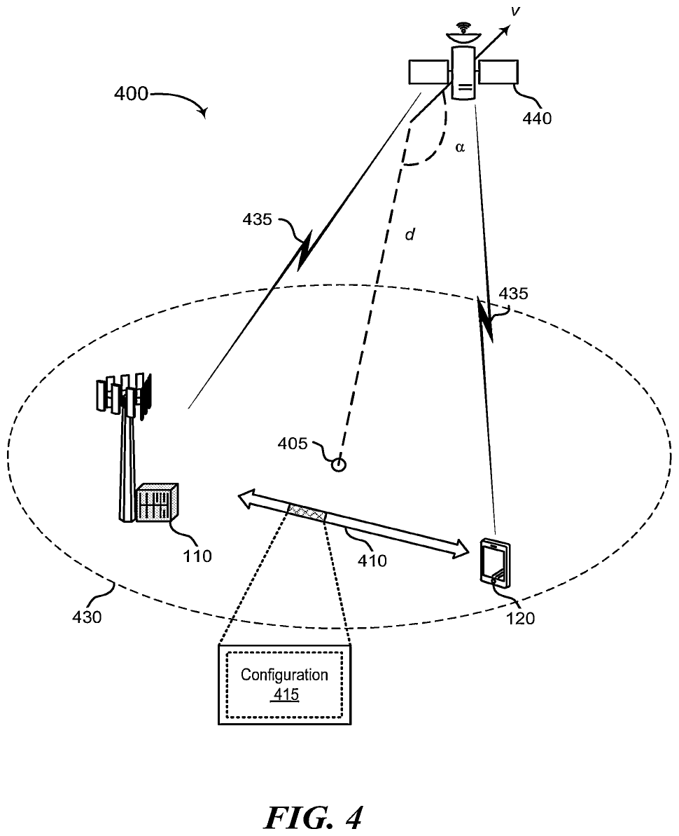

FIG. 4 is a block diagram illustrating an example of a wireless communications network 400 for non-terrestrial networks in accordance with various aspects of the present disclosure. In some examples, the wireless communications network 400 may implement aspects of the wireless network 100. The wireless communications network 400 may include a base station 110 and a UE 120, which may be examples of the corresponding devices described with reference to FIGS. 1, 2, and 3. For example, the wireless communications network 400 may be a non-terrestrial network, which may include a base station 110, a UE 120, and a satellite 440. The satellite 440 may relay communications for base stations (e.g., base station 110) and mobile terminals (e.g., UE 120). The base station 110 may also be referred to as a gateway. A geographical area associated with a transmission beam of the satellite 440 may be referred to as a beam footprint 430 and the UE 120 may communicate with the satellite 440 when the UE 120 is located within the beam footprint 430.

The base station 110 may perform a communication procedure (e.g., a radio resource control (RRC) procedure, such as a cell acquisition procedure, random access procedure, RRC connection procedure, or RRC configuration procedure) with the UE 120. The base station 110 may be configured with multiple antennas, which may be used for directional or beamformed transmissions. As part of the communication procedure, the base station 110 may establish a bi-directional communication link 410 for communication with the UE 120. Additionally, or alternatively, as part of the communication procedure, the base station 110 may configure the UE 120 with a configuration 415 (e.g., time and frequency resources, a reference signal periodicity, or an indication of a symbol of a slot for transmitting reference signals) via RRC signaling. Although shown communicating directly in FIG. 4, the present disclosure focuses on communications of the UE 120 to the base station 110 via the satellite 440.

The satellite 440 may generate satellite information (e.g., ephemeris information) associated with communications between the satellite 440, the UE 120, and the base station 110. The satellite may be a low Earth orbit (LEO), medium Earth orbit (MEO) or geostationary Earth orbit (GEO) satellite. For example, the satellite 440 may determine a propagation delay associated with transmissions between the satellite 440, the UE 120, and the base station 110. In some cases, the propagation delay may be based on the distance d from the satellite 440 to a point 405 (e.g., center) of the beam footprint 430. For LEO, the distance may be less than 1200 miles, for MEO the distance may between 1200 miles and 22,236 miles, and for GEO the distance may be approximately 22,3000 miles. In other cases, the propagation delay may be a factor of the distance d, which may correspond to the round-trip distance between the base station 110 and the satellite 440. Additionally, or alternatively, the propagation delay may be an estimated round-trip delay or a round-trip time between the UE 120 and the base station 110, which may be based at least in part on the distance d and/or 2d. It should be noted that the distance d may not reflect the precise distance from the satellite 440 to the UE 120. For example, the UE 120 may be located at an edge of the beam footprint 430 and may be a different distance from the satellite 440 than the distance d.

The satellite 440 may transmit, via wireless communication links 435, the satellite information to the base station 110 and/or the UE 120, which may be located within the beam footprint 430. In some cases, the satellite 440 may update and transmit the satellite information to the base station 110 and/or the UE 120 at a preconfigured schedule (e.g., an update rate). The preconfigured schedule may be based on a velocity of the satellite 440. For example, the velocity of the satellite 440 may result in a maximum round-trip time variation rate of 50 μs per second. That is, for every second of movement of the satellite 440, the round-trip time of communications between the satellite 440 and the UE 120, for example, may vary by 50 μs. The round-trip time variation rate may also vary based on the movement of the satellite (e.g., orbit). In such instances, the satellite 440 may update the satellite information multiple times every second. Additionally, or alternatively, the base station 110 may transmit the satellite information to the UE 120 via the bi-directional communication link 410, for example, as part of the configuration 415. In some cases, the base station 110 may transmit the satellite information to the UE 120 based on the preconfigured schedule, for example, the update rate of the satellite 440.

The satellite information may include the velocity of the satellite 440. The velocity of the satellite 440 may, in some cases, be defined by or relate to the following expression ν×cos(α), where α is the angle between the vector of velocity ν and the vector of distance d. The UE 120 may use the velocity of the satellite 440 to determine the round-trip time variation rate. In some cases, the UE 120 may determine the round-trip time variation rate using the velocity of the satellite 440 based at least in part on the UE 120 being located relative to the point 405 of the beam footprint 430. In some examples, using the velocity of the satellite 440, the round-trip time variation rate may be defined by the following expression −2ν×cos(α)/c, where α is the angle between the vector of velocity ν and the vector of distance d, and c is the speed of light. As such, if an upstream transmission is scheduled to be transmitted at time t₀ with a timing adjustment tₐ, the actual transmission time by the UE 120 may be t₀+tₐ. For a subsequent upstream transmission scheduled to be transmitted at time tₐ+Δt without a new timing adjustment provided by the base station 110, the actual transmission time by the UE 120 may be tₐ+Δt×(−2ν×cos(α)/c).

For non-terrestrial networks (NTN), it would be desirable for a user equipment (UE) to display an icon indicating whether the UE is in a coverage area of a non-terrestrial network. Such an icon is desirable because NTN service may be considered a different service than cellular service. Aspects of the present disclosure are related to techniques for displaying an NTN icon.

An NTN may be available regardless of the availability of a terrestrial network. Generally, a terrestrial network has a higher priority than a non-terrestrial network. A system information block (SIB) message (e.g., SIB 19) in the new radio (NR) terrestrial network carries information about the non-terrestrial network, such as inter-radio access technology (IRAT) frequency information. The SIB 19 information enables a UE to camp on the non-terrestrial network. It is noted that non-terrestrial network coverage may only be available in certain environments due to the line of sight requirements for communicating in a non-terrestrial network. Indoor environments may experience poor signal conditions, while a signal from the non-terrestrial network may be strong in outdoor environments.

According to aspects of the present disclosure, an NTN icon may be displayed with multiple variations. If a UE is camped on a terrestrial network and a SIB 19 message is not received, or if the UE is not camped on a terrestrial network and the UE cannot find a non-terrestrial network to camp on, an NTN icon is not displayed.

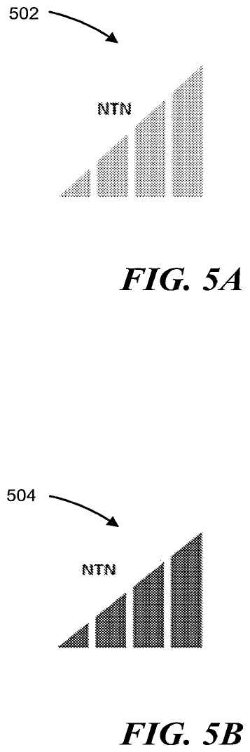

If the UE is camped on a terrestrial network and the SIB 19 message is received, then an NTN icon is displayed to indicate availability of the non-terrestrial network. In some aspects, the NTN icon is displayed with low brightness or empty bars when the non-terrestrial network is available but not camped on. FIG. 5A is a diagram illustrating a non-terrestrial network coverage icon 502, in accordance with various aspects of the present disclosure. The non-terrestrial network coverage icon 502 may also simply be referred to as an NTN icon 502. In the example shown in FIG. 5A, the NTN icon 502 includes the symbols ‘NTN’ and shows a number of bars to indicate a signal strength of the non-terrestrial network. Although the symbols ‘NTN’ are seen in the example of FIG. 5A, the present disclosure is not so limited. The NTN icon 502 can be displayed with symbols such as ‘N,’ ‘SAT,’ or ‘S,’ for example. In the example of FIG. 5A, the NTN icon 502 is displayed with low brightness.

Although not shown in FIG. 5A, if the UE has a poor signal from the non-terrestrial network while the non-terrestrial network is available, the NTN icon may be displayed with low brightness and strikeout. The poor signal may result from an indoor location of the UE. The low brightness with strikeout may indicate presence of the non-terrestrial network but the inability to camp on the non-terrestrial network.

If the UE is camped on a non-terrestrial network, an NTN icon may be displayed with high brightness. FIG. 5B is a diagram illustrating a high brightness (or filled bars) non-terrestrial network coverage icon 504 (or NTN icon 504), in accordance with various aspects of the present disclosure. In the example shown in FIG. 5B, the NTN icon 504 includes the symbols ‘NTN’ and shows a number of bars to indicate a signal strength of the non-terrestrial network. Although the symbols ‘NTN’ are seen in the example of FIG. 5B, the present disclosure is not so limited. The NTN icon 504 can be displayed with symbols such as ‘N,’ ‘SAT,’ or ‘S,’ for example. In the example of FIG. 5B, the NTN icon 504 is displayed with high brightness.

If the UE moves to a location where the signal becomes poor and the UE loses coverage (and the UE is not camped on any terrestrial network), the NTN icon 504 is displayed with high brightness and strikeout (not shown). In other implementations of this scenario (not shown), the NTN icon 504 is displayed with no (or fewer) bars filled, low brightness, or partially high brightness. The signal may become poor, for example, if the UE moves indoors or the satellite moves further away from the UE. The strikeout (or other implementations) will help the user know that non-terrestrial network coverage may be available if the UE moves outdoors where the signal may become stronger. Once the UE moves outdoors and re-camps on the non-terrestrial network, the NTN icon 504 is displayed again with high brightness and no strikeout. If at any time the UE camps on a terrestrial network, then the NTN icon will be displayed with low brightness, as seen for example in FIG. 5A.

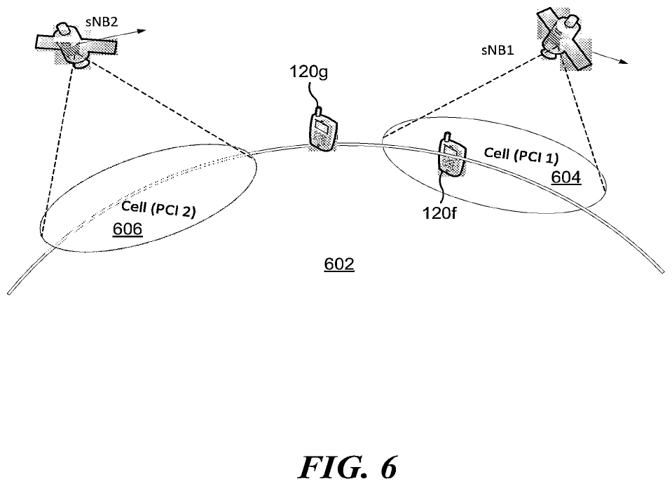

Coverage of non-terrestrial networks may not be continuous. In other words, there may be coverage gaps. FIG. 6 is a block diagram illustrating a coverage gap in a non-terrestrial network, in accordance with various aspects of the present disclosure. In the example of FIG. 6, a UE 120f on Earth 602 is in a coverage area (e.g., cell) 604 of a first satellite NodeB (sNB1). The first coverage area 604 has a physical cell ID of 1 (PCI 1). A coverage area (e.g., cell) 606 of a second satellite NodeB (sNB2) has a physical cell ID of 2 (PCI 2). Both satellites sNB1, sNB2 are moving from left to right across the page, as seen by the arrows. As a result of the movement, a UE 120g, which is currently in a coverage gap, will eventually fall into the coverage area 606 of the satellite sNB2. The UE 120f will eventually enter the coverage gap, before falling into the coverage area 606 of the satellite sNB2.

A coverage gap duration may be indicated via a system information block (SIB) message (e.g., through the ephemeris) or separate radio resource control (RRC) signaling. According to aspects of the present disclosure, a non-terrestrial network coverage gap time may be displayed as part of an NTN icon. The coverage gap time may be displayed, for example, as a subscript or a superscript, while the NTN icon is displayed with strikeout.

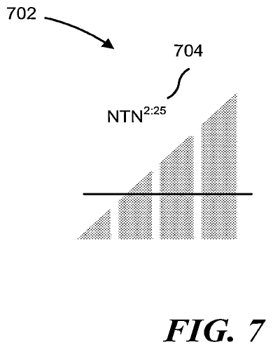

FIG. 7 is a block diagram illustrating a non-terrestrial network coverage icon 702 during a coverage gap, in accordance with various aspects of the present disclosure. In the example of FIG. 7, a timer 704 associated with the symbols ‘NTN’ is shown in superscript. In this example, the timer indicates two hours and 25 minutes. The timer may update periodically, for example, every second or every ten seconds, etc. In case seconds are not displayed (such as in the example of FIG. 7), the timer may update every minute. The timer informs the user when non-terrestrial network service will return. Such a timer is especially advantageous if the user is in a remote area where no terrestrial network coverage is available. The NTN icon 702 is shown with strikeout in the example of FIG. 7.

The NTN icon provides numerous advantages. For example, if service on the non-terrestrial network is more expensive than service on the terrestrial network (e.g., call rate, data rate, etc.), or vice-versa if the terrestrial network is cheaper, the NTN icon may allow the user to switch to a less expensive network. A non-terrestrial network may not provide certain features, such as low latency, due to high round-trip times (RTTs). Thus, certain applications may not be efficient when camped on a non-terrestrial network. With the presence of the NTN icon, the user can decide whether the application should be used. If a non-terrestrial network has benefits over a terrestrial network in terms of data rate, continuous connectivity, etc., a user may sometimes prefer the non-terrestrial network. In the case of discontinuous non-terrestrial network coverage, it would be beneficial for the user to know when the non-terrestrial network coverage will return. The user can plan accordingly.

As indicated above, FIGS. 4-7 are provided as examples. Other examples may differ from what is described with respect to FIGS. 4-7.

FIG. 8 is a diagram illustrating an example process 800 performed, for example, by a UE, in accordance with various aspects of the present disclosure. The example process 800 is an example of icon display for non-terrestrial networks. The operations of the process 800 may be implemented by a UE 120.

At block 802, the user equipment (UE) scans a wireless network for a system information message containing inter-radio access technology (IRAT) frequency information for a non-terrestrial network. For example, the UE (e.g., using the antenna 252, DEMOD/MOD 254, MIMO detector 256, receive processor 258, controller/processor 280, memory 282, and/or the like) may scan the wireless network. The UE may also receive an indication of a coverage gap for the non-terrestrial network, and display a timer indicating a duration of the coverage gap. The timer may be displayed as a subscript of the non-terrestrial network icon or a superscript of the non-terrestrial network icon. In this case, UE may display a strikethrough of the non-terrestrial network icon during the coverage gap.

At block 804, the user equipment (UE) displays a non-terrestrial network icon on a user interface of the UE in response to receiving the system information message. The icon indicates non-terrestrial network coverage. For example, the UE (e.g., using the controller/processor 280, memory 282, and/or the like) may display the non-terrestrial network icon. In some aspects, the UE displays the icon with a low brightness when the UE is camped on a terrestrial network and displays the icon with strikethrough in response to detecting the UE is indoors or a received signal level of the non-terrestrial network is below a threshold value. The UE may display the icon with a high brightness when the UE is camped on the non-terrestrial network. The UE may display the icon with strikethrough and with a high brightness when the UE is not camped on a terrestrial network, in response to detecting the UE is indoors or in response to a received signal level of the non-terrestrial network being below a threshold value.

### Example Aspects

Aspect 1: A method of wireless communication, by a user equipment (UE), comprising: scanning a wireless network for a system information message containing inter-radio access technology (IRAT) frequency information for a non-terrestrial network: and displaying a non-terrestrial network icon on a user interface of the UE in response to receiving the system information message, the icon indicating non-terrestrial network coverage.
Aspect 2: The method of Aspect 1, in which the displaying comprises displaying the icon with a low brightness when the UE is camped on a terrestrial network.
Aspect 3: The method of Aspect 1 or 2, in which the displaying comprises displaying the icon with strikethrough in response to one of detecting the UE is indoors or a received signal level of the non-terrestrial network being below a threshold value.
Aspect 4: The method of any of the preceding Aspects, in which the displaying comprises displaying the icon with a high brightness when the UE is camped on the non-terrestrial network.
Aspect 5: The method of any of the preceding Aspects, in which the displaying comprises displaying the icon with strikethrough and with a high brightness when the UE is not camped on a terrestrial network, in response to detecting the UE is indoors or in response to a received signal level of the non-terrestrial network being below a threshold value.
Aspect 6: The method of any of the preceding Aspects, further comprising: receiving an indication of a coverage gap for the non-terrestrial network: and displaying a timer indicating a duration of the coverage gap.
Aspect 7: The method of any of the preceding Aspects, in which displaying the timer comprises displaying the timer as a subscript of the non-terrestrial network icon or a superscript of the non-terrestrial network icon, and the method further comprises displaying a strikethrough of the non-terrestrial network icon during the coverage gap.
Aspect 8: An apparatus for wireless communication by a user equipment (UE), comprising: a memory: and at least one processor coupled to the memory, the at least one processor configured: to scan a wireless network for a system information message containing inter-radio access technology (IRAT) frequency information for a non-terrestrial network: and to display a non-terrestrial network icon on a user interface of the UE in response to receiving the system information message, the icon indicating non-terrestrial network coverage.
Aspect 9: The apparatus of Aspect 8, in which the at least one processor is further configured to display the icon with a low brightness when the UE is camped on a terrestrial network.
Aspect 10: The apparatus of Aspect 8 or 9, in which the at least one processor is further configured to display the icon with strikethrough in response to one of detecting the UE is indoors or a received signal level of the non-terrestrial network being below a threshold value.
Aspect 11: The apparatus of any of the Aspects 8-10, in which the at least one processor is further configured to display the icon with a high brightness when the UE is camped on the non-terrestrial network.
Aspect 12: The apparatus of any of the Aspects 8-11, in which the at least one processor is further configured to display the icon with strikethrough and with a high brightness when the UE is not camped on a terrestrial network, in response to detecting the UE is indoors or in response to a received signal level of the non-terrestrial network being below a threshold value.
Aspect 13: The apparatus of any of the Aspects 8-12, in which the at least one processor is further configured: to receive an indication of a coverage gap for the non-terrestrial network: and to display a timer indicating a duration of the coverage gap.
Aspect 14: The apparatus of any of the Aspects 8-13, in which the at least one processor is further configured to display the timer as a subscript of the non-terrestrial network icon or a superscript of the non-terrestrial network icon, and to display a strikethrough of the non-terrestrial network icon during the coverage gap.
Aspect 15: An apparatus for wireless communication by a user equipment (UE), comprising: means for scanning a wireless network for a system information message containing inter-radio access technology (IRAT) frequency information for a non-terrestrial network: and means for displaying a non-terrestrial network icon on a user interface of the UE in response to receiving the system information message, the icon indicating non-terrestrial network coverage.
Aspect 16: The apparatus of Aspect 15, in which the means for displaying further comprises means for displaying the icon with a low brightness when the UE is camped on a terrestrial network.
Aspect 17: The apparatus of Aspect 15 or 16, in which the means for displaying further comprises means for displaying the icon with strikethrough in response to one of detecting the UE is indoors or a received signal level of the non-terrestrial network being below a threshold value.
Aspect 18: The apparatus of any of the Aspects 15-17, in which the means for displaying further comprises means for displaying the icon with a high brightness when the UE is camped on the non-terrestrial network.
Aspect 19: The apparatus of any of the Aspects 15-18, in which the means for displaying further comprises means for displaying the icon with strikethrough and with a high brightness when the UE is not camped on a terrestrial network, in response to detecting the UE is indoors or in response to a received signal level of the non-terrestrial network being below a threshold value.
Aspect 20: The apparatus of any of the Aspects 15-19, further comprising: means for receiving an indication of a coverage gap for the non-terrestrial network: and means for displaying a timer indicating a duration of the coverage gap.
Aspect 21: The apparatus of any of the Aspects 15-20, in which the means for displaying the timer further comprises means for displaying the timer as a subscript of the non-terrestrial network icon or a superscript of the non-terrestrial network icon, and the apparatus further comprises means for displaying a strikethrough of the non-terrestrial network icon during the coverage gap.
Aspect 22: A non-transitory computer-readable medium having program code recorded thereon, the program code executed by a processor of a user equipment (UE) and comprising: program code to scan a wireless network for a system information message containing inter-radio access technology (IRAT) frequency information for a non-terrestrial network: and program code to display a non-terrestrial network icon on a user interface of the UE in response to receiving the system information message, the icon indicating non-terrestrial network coverage.
Aspect 23: The non-transitory computer-readable medium of Aspect 22, in which the program code to display further comprises program code to display the icon with a low brightness when the UE is camped on a terrestrial network.
Aspect 24: The non-transitory computer-readable medium of Aspect 22 or 23, in which the program code to display further comprises program code to display the icon with strikethrough in response to one of detecting the UE is indoors or a received signal level of the non-terrestrial network being below a threshold value.
Aspect 25: The non-transitory computer-readable medium of any of the Aspects 22-24, in which the program code to display further comprises program code to display the icon with a high brightness when the UE is camped on the non-terrestrial network.
Aspect 26: The non-transitory computer-readable medium of any of the Aspects 22-25, in which the program code to display further comprises program code to display the icon with strikethrough and with a high brightness when the UE is not camped on a terrestrial network, in response to detecting the UE is indoors or in response to a received signal level of the non-terrestrial network being below a threshold value.
Aspect 27: The non-transitory computer-readable medium of any of the Aspects 22-26, in which the program code further comprises: program code to receive an indication of a coverage gap for the non-terrestrial network: and program code to display a timer indicating a duration of the coverage gap.
Aspect 28: The non-transitory computer-readable medium of any of the Aspects 22-27, in which the program code to display the timer further comprises program code to display the timer as a subscript of the non-terrestrial network icon or a superscript of the non-terrestrial network icon, and the program code further comprises program code to display a strikethrough of the non-terrestrial network icon during the coverage gap.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code-it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

1. A method of wireless communication, by a user equipment (UE), comprising:
scanning a wireless network for a system information message containing inter-radio access technology (IRAT) frequency information for a non-terrestrial network;
displaying a non-terrestrial network icon on a user interface of the UE in response to receiving the system information message, the icon indicating non-terrestrial network coverage;
determining whether the UE is camped on a terrestrial network or camped on the non-terrestrial network;
displaying the icon in a first manner in response to determining the UE is camped on a terrestrial network; and
displaying the icon in a second manner in response to determining the UE is camped on a terrestrial network, the second manner being different from the first manner.

2. The method of claim 1, in which the displaying the icon in the first manner comprises displaying the icon with a low brightness when the UE is camped on the terrestrial network.

3. The method of claim 2, in which the displaying comprises displaying the icon with strikethrough in response to one of detecting the UE is indoors or a received signal level of the non-terrestrial network being below a threshold value.

4. The method of claim 1, in which the displaying the icon in the second manner comprises displaying the icon with a high brightness when the UE is camped on the non-terrestrial network.

5. The method of claim 1, in which the displaying comprises displaying the icon with strikethrough and with a high brightness when the UE is not camped on a terrestrial network, in response to detecting the UE is indoors or in response to a received signal level of the non-terrestrial network being below a threshold value.

6. The method of claim 1, further comprising:
receiving an indication of a coverage gap for the non-terrestrial network; and
displaying a timer indicating a duration of the coverage gap.

7. The method of claim 6, in which displaying the timer comprises displaying the timer as a subscript of the non-terrestrial network icon or a superscript of the non-terrestrial network icon, and the method further comprises displaying a strikethrough of the non-terrestrial network icon during the coverage gap.

8. An apparatus for wireless communication by a user equipment (UE), comprising:
at least one memory; and
at least one processor coupled to the at least one memory, the at least one processor configured:
to scan a wireless network for a system information message containing inter-radio access technology (IRAT) frequency information for a non-terrestrial network;
to display a non-terrestrial network icon on a user interface of the UE in response to receiving the system information message, the icon indicating non-terrestrial network coverage;
to determine whether the UE is camped on a terrestrial network or camped on the non-terrestrial network;
to display the icon in a first manner in response to determining the UE is camped on a terrestrial network; and
to display the icon in a second manner in response to determining the UE is camped on a terrestrial network, the second manner being different from the first manner.

9. The apparatus of claim 8, in which the at least one processor is further configured to display the icon in the first manner by displaying the icon with a low brightness when the UE is camped on the terrestrial network.

10. The apparatus of claim 9, in which the at least one processor is further configured to display the icon with strikethrough in response to one of detecting the UE is indoors or a received signal level of the non-terrestrial network being below a threshold value.

11. The apparatus of claim 8, in which the at least one processor is further configured to display the icon in the second manner by displaying the icon with a high brightness when the UE is camped on the non-terrestrial network.

12. The apparatus of claim 8, in which the at least one processor is further configured to display the icon with strikethrough and with a high brightness when the UE is not camped on a terrestrial network, in response to detecting the UE is indoors or in response to a received signal level of the non-terrestrial network being below a threshold value.

13. The apparatus of claim 8, in which the at least one processor is further configured:
to receive an indication of a coverage gap for the non-terrestrial network; and
to display a timer indicating a duration of the coverage gap.

14. The apparatus of claim 13, in which the at least one processor is further configured to display the timer as a subscript of the non-terrestrial network icon or a superscript of the non-terrestrial network icon, and to display a strikethrough of the non-terrestrial network icon during the coverage gap.

15. An apparatus for wireless communication by a user equipment (UE), comprising:
means for scanning a wireless network for a system information message containing inter-radio access technology (IRAT) frequency information for a non-terrestrial network;
means for displaying a non-terrestrial network icon on a user interface of the UE in response to receiving the system information message, the icon indicating non-terrestrial network coverage;
means for determining whether the UE is camped on a terrestrial network or camped on the non-terrestrial network;
means for displaying the icon in a first manner in response to determining the UE is camped on a terrestrial network; and
means for displaying the icon in a second manner in response to determining the UE is camped on a terrestrial network, the second manner being different from the first manner.

16. The apparatus of claim 15, in which the means for displaying the icon in the first manner further comprises means for displaying the icon with a low brightness when the UE is camped on the terrestrial network.

17. The apparatus of claim 16, in which the means for displaying further comprises means for displaying the icon with strikethrough in response to one of detecting the UE is indoors or a received signal level of the non-terrestrial network being below a threshold value.

18. The apparatus of claim 15, in which the means for displaying the icon in the second manner further comprises means for displaying the icon with a high brightness when the UE is camped on the non-terrestrial network.

19. The apparatus of claim 15, in which the means for displaying further comprises means for displaying the icon with strikethrough and with a high brightness when the UE is not camped on a terrestrial network, in response to detecting the UE is indoors or in response to a received signal level of the non-terrestrial network being below a threshold value.

20. The apparatus of claim 15, further comprising:
means for receiving an indication of a coverage gap for the non-terrestrial network; and
means for displaying a timer indicating a duration of the coverage gap.

21. The apparatus of claim 20, in which the means for displaying the timer further comprises means for displaying the timer as a subscript of the non-terrestrial network icon or a superscript of the non-terrestrial network icon, and the apparatus further comprises means for displaying a strikethrough of the non-terrestrial network icon during the coverage gap.

22. A non-transitory computer-readable medium having program code recorded thereon, the program code executed by a processor of a user equipment (UE) and comprising:
program code to scan a wireless network for a system information message containing inter-radio access technology (IRAT) frequency information for a non-terrestrial network;
program code to display a non-terrestrial network icon on a user interface of the UE in response to receiving the system information message, the icon indicating non-terrestrial network coverage;
program code to determine whether the UE is camped on a terrestrial network or camped on the non-terrestrial network;
program code to display the icon in a first manner in response to determining the UE is camped on a terrestrial network; and
program code to display the icon in a second manner in response to determining the UE is camped on a terrestrial network, the second manner being different from the first manner.

23. The non-transitory computer-readable medium of claim 22, in which the program code to display the icon in the first manner further comprises program code to display the icon with a low brightness when the UE is camped on the terrestrial network.

24. The non-transitory computer-readable medium of claim 23, in which the program code to display further comprises program code to display the icon with strikethrough in response to one of detecting the UE is indoors or a received signal level of the non-terrestrial network being below a threshold value.

25. The non-transitory computer-readable medium of claim 22, in which the program code to display the icon in the second manner further comprises program code to display the icon with a high brightness when the UE is camped on the non-terrestrial network.

26. The non-transitory computer-readable medium of claim 22, in which the program code to display further comprises program code to display the icon with strikethrough and with a high brightness when the UE is not camped on a terrestrial network, in response to detecting the UE is indoors or in response to a received signal level of the non-terrestrial network being below a threshold value.

27. The non-transitory computer-readable medium of claim 22, in which the program code further comprises:
program code to receive an indication of a coverage gap for the non-terrestrial network; and
program code to display a timer indicating a duration of the coverage gap.

28. The non-transitory computer-readable medium of claim 27, in which the program code to display the timer further comprises program code to display the timer as a subscript of the non-terrestrial network icon or a superscript of the non-terrestrial network icon, and the program code further comprises program code to display a strikethrough of the non-terrestrial network icon during the coverage gap.
